(19) United States
(12) Patent Application Publication
(10) Pub. No.: US 2015/0334185 A1
(43) Pub. Date: Nov. 19, 2015

(54) TERMINAL DEVICE, PROGRAM, DATA TRANSMISSION/RECEPTION SYSTEM, AND DATA TRANSMISSION/RECEPTION METHOD

(71) Applicant: HITACHI CONSUMER ELECTRONICS CO., LTD., Chiyoda-ku, Tokyo (JP)

(72) Inventor: Susumu YOSHIDA, Tokyo (JP)

(21) Appl. No.: 14/655,207

(22) PCT Filed: Mar. 27, 2013
(86) PCT No.: PCT/JP2013/058903

§ 371 Date: Jun. 24, 2015

(51) Int. Cl. H04L 29/08; G06F 3/0484

(52) U.S. Cl. CPC H04L 67/1097; G06F 3/04842

(57) ABSTRACT

When data transmission/reception is performed between different services on a network, data acquired by one of the services needs to be updated to the other of the services after being once downloaded to a user terminal. In the present invention, information for an access and charging of a fee is notified, as appropriate, to a server in a service requiring the information, and information for a data request or an access is notified from the server to a server in the other service. Because a data transfer is performed between the servers, data transmission/reception can be performed smoothly without the intervention of a user terminal.

### TECHNICAL FIELD

The present invention relates to a system, a method, a program, and a terminal device concerning data transmission/reception.

### BACKGROUND ART

As for a utilization form of a computer based on a network, a term “cloud computing” has been used in recent years instead of a conventional term “network computing.” In cloud computing, a user such as an enterprise does not retain software, hardware functioning as a storage, a large amount of data, and so forth itself, and enjoys them as service via a network. In addition, a large number of cloud services intended for personal users have been provided in recent years. It has become possible for personal users to share data among terminals by utilizing a storage on the network.

As for a conventional technique of data transmission/reception on the network, there is Patent Literature 1. In Patent Literature 1, a problem is to provide a data sending system that makes possible rapid data exchange between stationary users and that is excellent in safety. As the solution to problem, there is the following statement. “In a system in which data is sent from a user A to a user B, at least cloud service including a data store A which stores an encrypted database of the user A and a data store B which stores an encrypted database of the user B is provided. Upon receiving data sending information from the user A outside the cloud service to the user B, the data store A encrypts encrypted data in the data store A by using a public key of the user B and transfers resultant data to the data store B. The data store B stores the encrypted data or data obtained by further encrypting the encrypted data in the data store B. In addition, data sending information from the user A is transmitted to the user B outside the cloud service.”

As a further different conventional technique, there is a technique stated in Patent Literature 2. In Patent Literature, dependence of utilization of downloaded data upon the device is regarded as a problem. As the solution to problem, there is the following statement. “Contents protection is managed as cloud service. To be more precise, contents are protected remotely. A key is distributed toward individuals authenticated on demand to unlock contents. In addition, this system is centering around identification, and is not centering around a device. The identification is authenticated by comparing initial user and/or third person information with provided information to prove legality of identification with high reliability. As a result, it becomes possible for a user having the right to access protected contents from anywhere in arbitrary network device.”

### CITATION LIST

### Patent Literature

PATENT LITERATURE 1: JP-A-2012-42782
PATENT LITERATURE 2: JP-A-2010-505206

### SUMMARY OF INVENTION

### Technical Problem

Usually, an individual user acquires desired contents from among a plurality of contents providers, selects a desired service from among a plurality of cloud services contracted individually, and stores the acquired data into a storage in the cloud service. An individual user conducts such utilization. In a case where the contents provider and the cloud service provider are the same, the acquired data is handled in one cloud service. In a case where the contents provider and the cloud service provider are not the same, basically the acquired data is once downloaded to a terminal of the user, and then uploaded to a storage in the selected cloud service, but in such a case, convenience of the user has not been considered.

In the above-described conventional techniques, techniques concerning data sending and contents protection on the network are disclosed. However, both techniques are shown as techniques in the same cloud service, that is, a technique that can be provided in a single server, and handling of data between different servers existing on a network has not been touched upon especially.

In view of such a point, the present invention has been made. An object of the present invention is to improve convenience of data transmission/reception at the time when acquiring data from the network.

### Solution to Problem

The above-described problem and object are improved by, for example, the invention stated in claims.

### Advantageous Effects of Invention

According to the present invention, data transmission/reception can be conducted smoothly even in a case where data between different servers existing on a network is handled, and convenience for the user can be improved.

### BRIEF DESCRIPTION OF DRAWINGS

FIG. 1 is a schematic diagram showing a first embodiment of a data transmission/reception system;

FIG. 2 is an operation flow in the first embodiment;

FIG. 3 is a block diagram showing an example of a configuration of a mobile terminal 102;

FIG. 4 is an operation flow of data download from contents providing service 104;

FIG. 5 is an operation flow of data upload to cloud service 108;

FIG. 6 is an operation flow in a second embodiment;

FIG. 7 shows an example of a display output in the mobile terminal 102;

FIG. 8 shows an example of a display output in the mobile terminal 102;

FIG. 9 shows an example of a display output in the mobile terminal 102;

FIG. 10 shows an example of a display output in the mobile terminal 102;

FIG. 11 shows an example of a display output in the mobile terminal 102;

FIG. 12 is a schematic diagram showing a fifth embodiment of the data transmission/reception system;

FIG. 13 is a schematic diagram showing a fifth embodiment of the data transmission/reception system; and

FIG. 14 is an operation flow in a sixth embodiment.

### DESCRIPTION OF EMBODIMENTS

Hereafter, embodiments of the present invention will be described with reference to the drawings.

### Embodiment 1

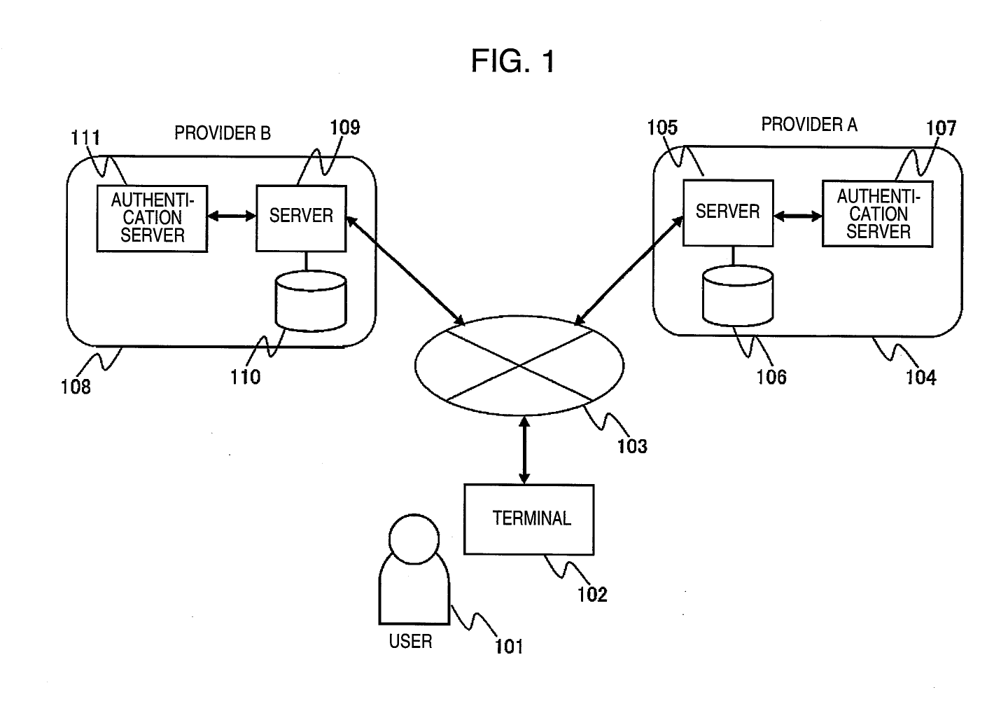

FIG. 1 is a schematic diagram showing a first embodiment of a data transmission/reception system according to the present embodiment. Reference numeral 101 denotes a user, 102 a mobile terminal of the user 101, 103 Internet, 104 contents providing service (data providing subsystem) provided by a predetermined contents provider A, 105 a server in the contents providing service 104, 106 a storage, and 107 an authentication server. Reference numeral 108 denotes cloud service (data storing subsystem) provided by a service provider B, 109 a server in the cloud service 108, 110 a storage, and 111 an authentication server. By the way, the mobile terminal 102 is not restricted in form to a mobile terminal as long as it is a device, such as a personal computer, that accesses the network.

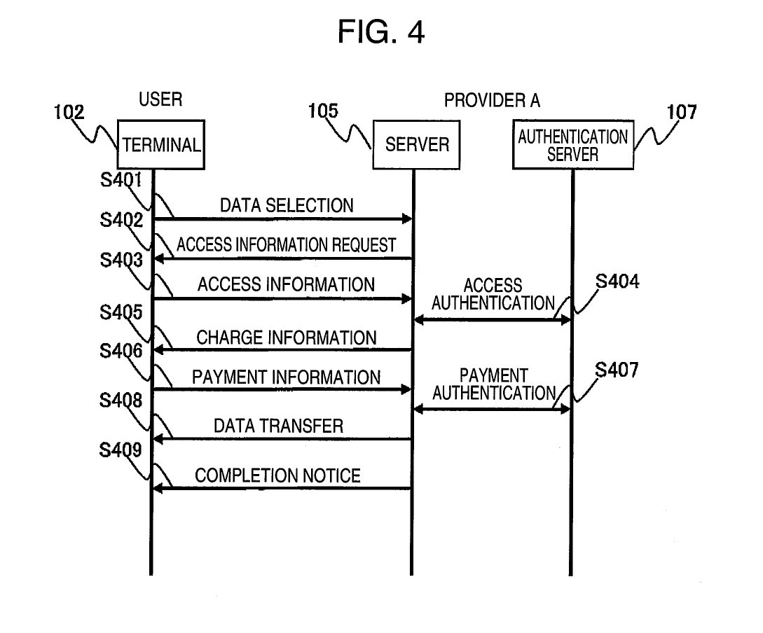

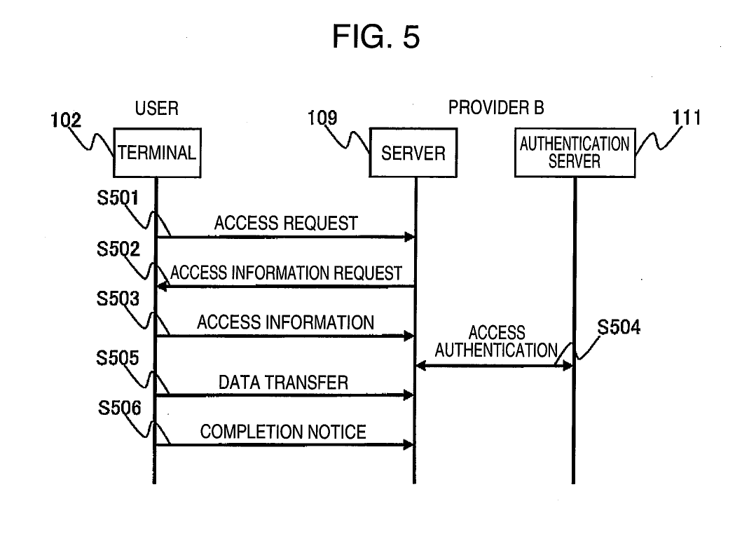

Individual operation of data download from the contents providing service 104 and data upload to the cloud service 108 will now be described with reference to FIG. 4 and FIG. 5.

FIG. 4 is a diagram showing an operation flow of data download from the contents providing service 104. As for the configuration, the operation corresponds to operations in the mobile terminal 102, the Internet 103, and the contents providing service 104 in FIG. 1. Therefore, the operation flow will be described by using the reference numerals in FIG. 1.

The user 101 accesses the contents providing service 104 provided by the contents provider A, via the Internet 103 by using the mobile terminal 102 in order to acquire desired data. Usually, the contents provider A prepares the server 105, and provides, for example, web pages in the HTML form. The user 101 accesses the web page via the Internet 103 by using a web browser in the mobile terminal 102, and selects desired data from among data stored in the storage 106 (S401). The server 105 requests access information with respect to the data selection (S402). The user 101 inputs access information (such as a user ID and a password) to the mobile terminal 102, and the server 105 is notified of them (S403). The authentication server 107 conducts access authentication on the basis of the access information received by the server 105 (S404). If the access authentication has failed, a request for access information is issued again (not illustrated). If the access authentication has succeeded, the user is notified of charge information and so forth of the selected data (S405). The user 101 inputs payment information (such as a credit card number) to the mobile terminal 102. The server 105 is notified of the payment information (S406). Predetermined payment authentication is conducted in the authentication server 107 (S407). If the payment authentication has succeeded, the data is read out from the storage 106 by the server 105 and transferred to the mobile terminal 102 (S408). In the data transfer itself, a protocol such as the HTTP or FTP is used. If the data transfer is finished, the server 105 gives a completion notice to the mobile terminal 102 (S409). By the way, as for the web server and the data server that conducts the data transfer, there is a case of combined use as in the server 105 or a case of different configurations. By the way, besides a case where the contents provider A provides the web page, it is also possible for the contents provider A to provide dedicated application software depending upon the terminal of the user and cause the user to access the web server by using the application software.

Kinds of acquired data (contents) are diverse from usual text files to electronic book files, music files, image files and so forth. In particular, in a case where moving image data such as movie contents is handled as an image file, its data size becomes several gigabytes even if predetermined data compression using high efficiency encoding is conducted. Time required to download data depends upon the communication band. Even if the user 101 connects to the Internet by using a broadband line (having a transfer rate of at least several tens Mbits/sec) such as optical fiber, therefore, a long time is needed to acquire whole data in some cases.

Even in a case where data to be acquired is free of charge, a notice of the payment information is requested by the contents providing service 104 in some cases. Furthermore, there is a configuration in which once a notice of payment information is given in a state in which the access authentication is conducted steps corresponding to S406 and S407 are not necessary in subsequent access. In other words, it is possible to change each notice timing depending upon the policy of the contents providing service 104 without being restricted to the present embodiment. However, at least notice of the access information and the payment information is needed at some timing.

FIG. 5 is a diagram showing an operation flow of data upload to the cloud service 108. As for the configuration, the operation corresponds to operations in the mobile terminal 102, the Internet 103, and the cloud service 108 in FIG. 1. Therefore, the operation flow will be described by using the reference numerals in FIG. 1.

The user 101 accesses the cloud service 108 provided by the service provider B via the Internet 103 in order to upload data stored in a storage included in the mobile terminal 102 of the user himself or herself. Data transfer may be conducted by using the web page in the same way as the case of the above-described data download. Dedicated application software is provided. It is also possible to use the dedicated application software. Furthermore, the server 109 for conducting access via the Internet is prepared in the same way as the above-described case.

In a case where the user 101 uploads desired data, first the mobile terminal 102 issues an access request to the server 109 (S501). In response to this, the server 109 issues an access information request (S502). The user 101 inputs access information (such as a user ID and a password) to the mobile terminal 102, and the server 109 is notified of them (S503). The authentication server 111 conducts access authentication on the basis of the access information received by the server 109 (S504). In a case where the access authentication has failed, a request for access information is issued again (not illustrated). In a case where access authentication has succeeded, access is permitted and the data is transferred from the mobile terminal 102 to the server 109 and stored in the storage 110 (S505). If the transfer of the data is finished, the mobile terminal 102 issues a completion notice to the server 109 (S506).

By the way, there is also a configuration in which once access authentication is conducted, subsequent notice of access information, that is, steps corresponding to S502 to S504 are not necessary unless the user 101 cancels actively. In other words, it is possible to change timing and so forth of access authentication depending upon the policy of the cloud service 108 in the same way as the above-described case. However, at least notice of information for conducting the access authentication becomes necessary.

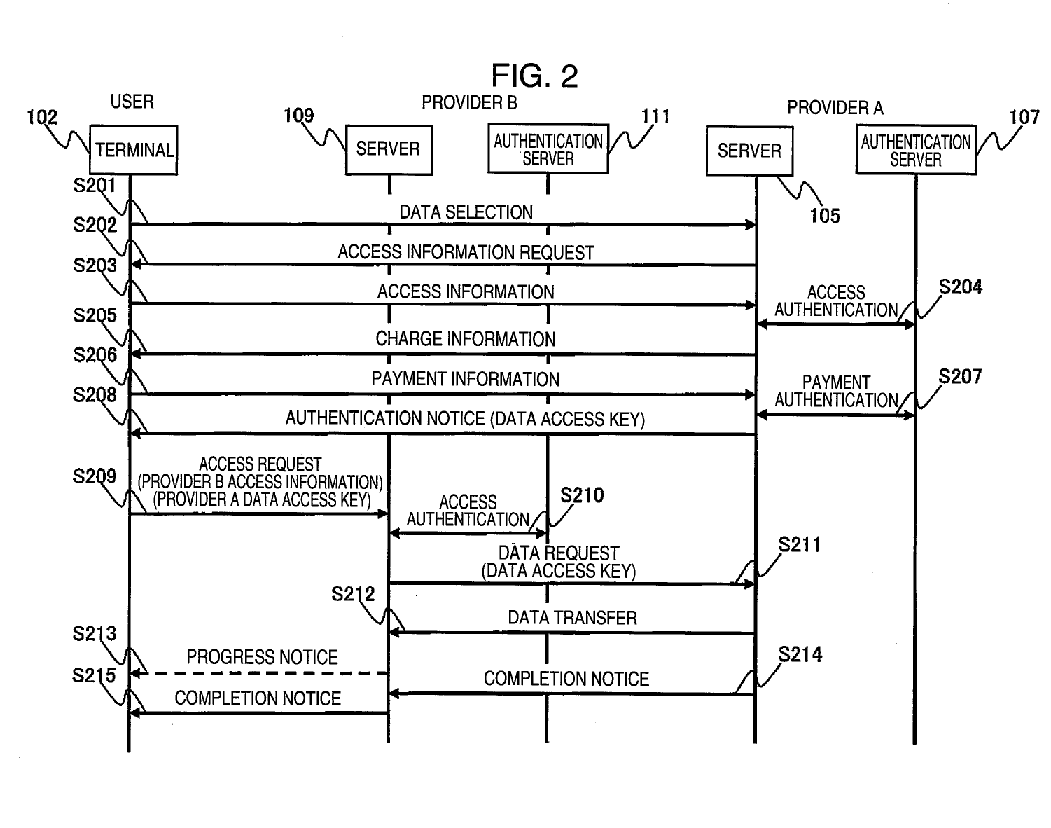

An operation of the data transmission/reception system shown in FIG. 1, which features the present embodiment, will now be described in detail with reference to the operation flow in FIG. 2.

The user 101 acquires desired data from the contents providing service 104, and stores the acquired data in the storage 110 in the cloud service 108 contracted by the user himself or herself Unlike the case of the above-described individual operation, however, the acquired data is not downloaded to the storage in the mobile terminal 102.

First, the user 101 accesses the contents providing service 104 provided by the contents provider A, via the Internet 103 by using the mobile terminal 102. A subsequent operation ranging from data selection in step S201 to payment authentication in step S207 is similar to the operation ranging from step S401 to step S407 in FIG. 4. Therefore, detailed description of the operation will be omitted. If the payment authentication in step S207 has succeeded, the server 105 gives a notice of authentication to the mobile terminal 102 (S208). In this case, the authentication notice includes a data access key, which makes access to the selected data possible. The user 101 issues an access request to the server 109 in the cloud service 108 by using the mobile terminal 102, and together therewith, the user 101 issues a notice of an access instruction (including a data access key) for access information in the cloud service 108 and the contents providing service 104 (S209). The authentication server 111 conducts access authentication on the basis of access information in the cloud service 108 received by the server 109 (S210). In a case where the access authentication has failed, a request for access information is issued to the mobile terminal 102 again (not illustrated). In a case where the access authentication has succeeded, the server 109 issues a data request to the server 105, and gives a notice of the above-described data access key to the server 105 on the basis of the above-described access instruction (S211). The server 105 reads out data selected by the user 101 in step S201 from the storage 106, on the basis of the data access key, and transfers the data to the server 109 (S212). The data server 109 stores received data in the storage 110. The server 109 gives a notice concerning progress of data transfer to the mobile terminal 102 successively or at suitable timing (S213). If data transfer is finished, the server 105 gives a completion notice to the server 109 (S214), and the server 109 gives a completion notice to the mobile terminal 102 (S215).

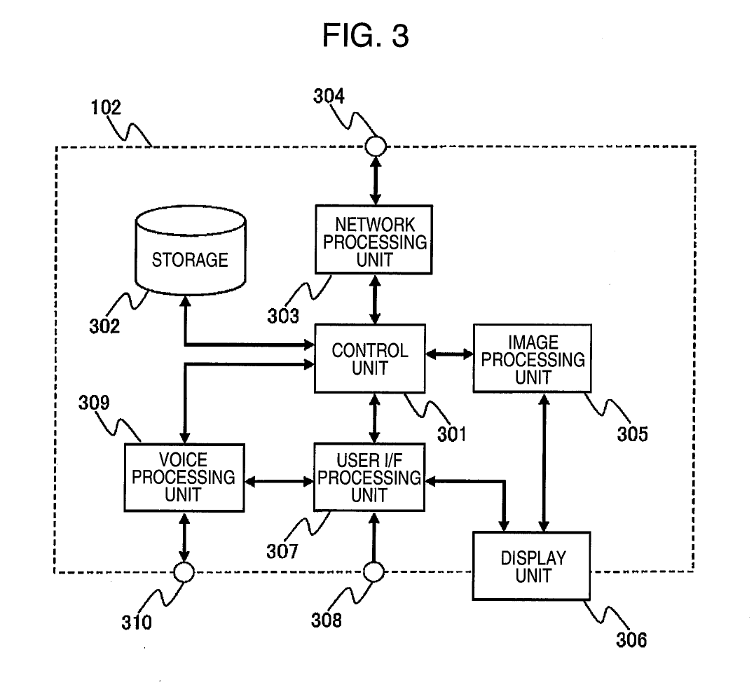

A configuration of the mobile terminal 102 will now be described in detail with reference to FIG. 3.

FIG. 3 is a block diagram showing an example of a configuration of the mobile terminal 102. Reference numeral 301 denotes a control unit which controls respective units in the mobile terminal 102, 302 a storage, 303 a network processing unit, 304 an input/output terminal for conducting data input/output from/to the network, and 305 an image processing unit which conducts encoding, decoding, image generation, and so forth of image data. Reference numeral 306 denotes a display unit which displays a generated image, 307 a user I/F (interface) processing unit which conducts processing on data input by the user, and 308 an input terminal which receives a key input and so forth. Reference numeral 309 denotes a voice processing unit which conducts voice encoding, decoding, mixing and so forth, and 310 a voice input/output terminal corresponding to a microphone, a speaker, and an earphone terminal. By the way, each of the network processing unit 303 and the network input/output terminal 304 is indicated as a single one. However, there is also a case where wireless input/outputs or wire inputs/outputs coexist, and connection to the network is not restricted to one form. Furthermore, as for the display unit 306, a touch panel or the like using a static capacitance system or the like is used, and a user's instruction input is received by using such a display unit in some cases. In that case, a configuration in which the display unit 306 is used as the input terminal 308 is obtained. In addition, there is also a case where the voice processing unit 309 processes a voice input from the voice input/output terminal 310 (microphone) and the user I/F unit 307 receives a result as a user's instruction input. Furthermore, in a case where a personal computer or the like is used instead of the mobile terminal 102 as described above, a configuration in which the display unit 306 is not incorporated in the terminal and an output terminal which outputs image data is provided may be used.

In the operation described with reference to FIG. 2, selection of data and the notice of access information are conducted as described hereafter. First, the user I/F processing unit 307 converts a user instruction input from the input terminal 308 or the display unit 306 to a predetermined code. The control unit 301 interprets the user instruction. The network processing unit generates required data, and transmits the generated data toward the Internet via the input/output terminal 304. Even in a case where data is uploaded to the cloud service 108, data read out from the storage 302 is transmitted via the input/output terminal 304 in the same way. Furthermore, in a case where predetermined data is received via the input/output terminal 304, the control unit 301 judges data processed in the network processing unit 303, causes the image processing unit to generate necessary image data, and displays an image on the display unit 306. In a case of data download and so forth, received data is stored in the storage 302.

According to the present embodiment, a notice of authentication information concerning access and charging is given to a suitable server, and mainly the cloud service is caused to operate to acquire data directly from the contents providing service, as described heretofore. Therefore, even in a case of between different servers as in the contents providing service and the cloud service, it becomes possible to conduct transmission/reception of data smoothly without passing through the user terminal, i.e., without pressing the data capacity of the storage incorporated in the user terminal hard.

### Embodiment 2

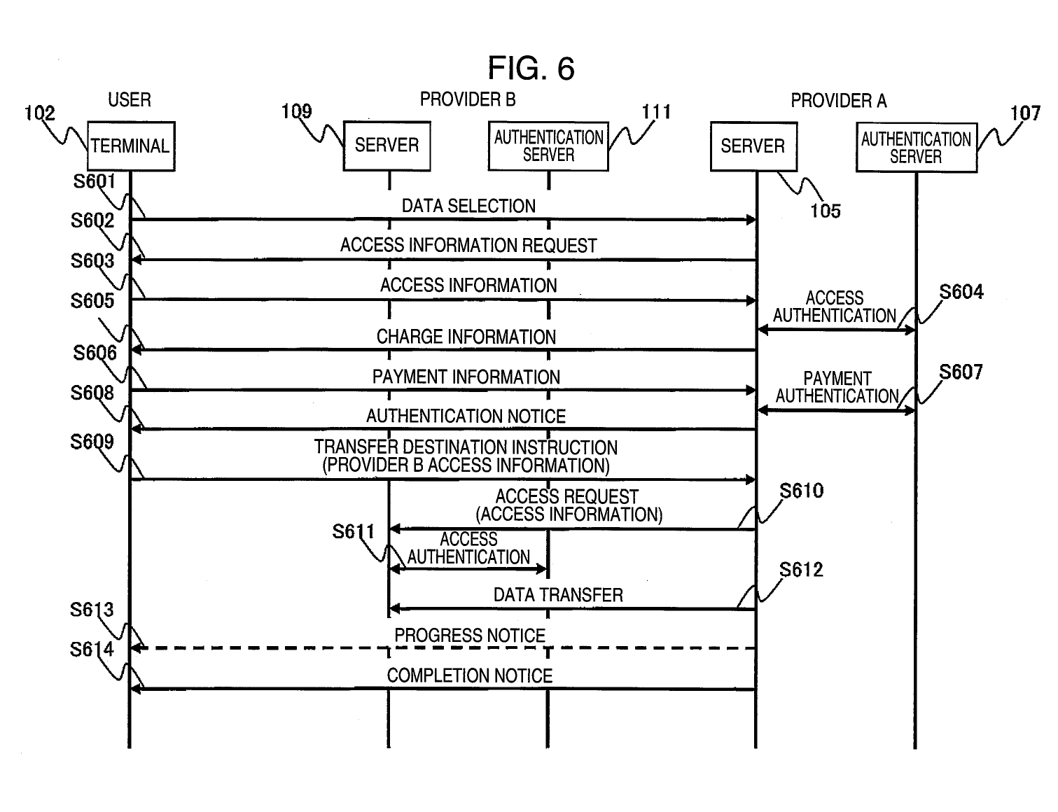

A second embodiment of the present invention will now be described with reference to FIG. 6.

FIG. 6 is a diagram showing an operation flow in a second embodiment of a data transmission/reception system according to the present invention. By the way, a schematic diagram of a system configuration is the same as FIG. 1. Therefore, the operation flow will be described by using the reference numerals in FIG. 1.

First, the user 101 accesses the contents providing service 104 provided by the contents provider A, via the Internet 103 by using the mobile terminal 102. A subsequent operation ranging from data selection in step S601 to payment authentication in step S607 is similar to the operation ranging from step S401 to step S407 in FIG. 4. Therefore, detailed description of the operation will be omitted. If the payment authentication has succeeded in step S607, the server 105 gives a notice of authentication to the user terminal 102 (S608). The user 101 gives a transfer destination instruction to the server 105 by using the mobile terminal 102 and gives a notice of access information of the cloud service 108 (S609). The server 105 issues an access request to the server 109, and gives a notice of the access information of the cloud service 108 to the server 109 (S610). The authentication server 111 conducts access authentication on the basis of the access information of the cloud service 108 received by the server 109 (S611). In a case where the access authentication has failed, a request for access information is issued to the server 105 again and the server 105 gives a notice of the request to the mobile terminal 102 (not illustrated). In a case where the access authentication has succeeded, the data selected by the user 101 in step S601 is read out from the storage 106 by the server 105, transferred to the server 109, and stored in the storage 110 (S612). The server 105 gives a notice concerning progress of data transfer to the mobile terminal 102 successively or at suitable timing (S613). If data transfer is finished, the server 105 gives a completion notice to the mobile terminal 102 (S614).

According to the present embodiment, a notice of authentication information concerning access and charging is given to a suitable server, and mainly the contents providing service is caused to operate to send data directly to the cloud service, as described heretofore. Therefore, even in a case of between different servers as in the contents providing service and the cloud service, it becomes possible to conduct transmission/reception of data smoothly without passing through the user terminal, i.e., without pressing the data capacity of the storage incorporated in the user terminal hard.

### Embodiment 3

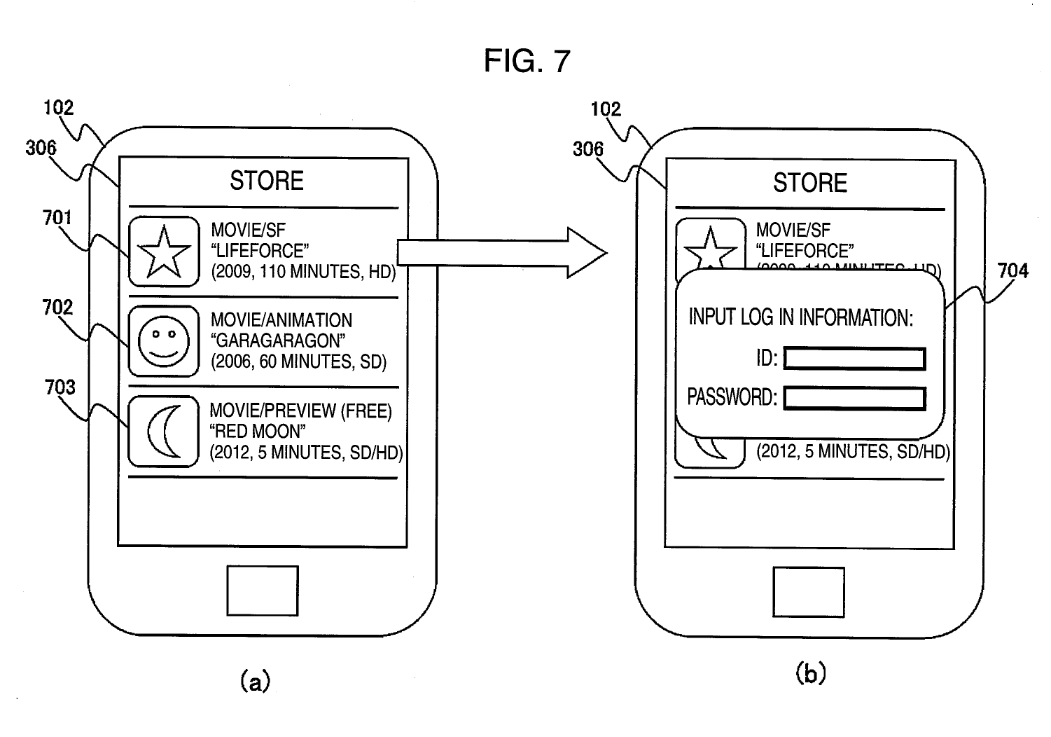

A third embodiment of the present invention will now be described with reference to FIGS. 7 to 10.

FIGS. 7 to 10 are diagrams showing an example of display outputs in the mobile terminal 102. Each of FIGS. 7 to 10 shows a display output of the display unit 306 in FIG. 3. In the ensuing description, it is supposed that the user conducts instruction input by using the touch panel as described above.

FIG. 7(a) shows a display output in a case where the user accesses the server 105 by using application software (for example, a program) or the like provided by the contents providing service 104 and used in, for example, the mobile terminal 102. Reference numerals 701, 702 and 703 denote icons in a case where the contents providing service 104 displays a list of retained data. The user can select desired data by touching one of the icons. This corresponds to the case of step S201 in FIG. 2.

FIG. 7(b) shows an example of a display output of the display unit 306 in a case where the user has selected the icon 701 in FIG. 7(a). As indicated by 704, input of a user ID and a password is requested as access information of the contents providing service 704 in order to proceed to detailed information of the contents and a purchase screen. This corresponds to the case of step S202 in FIG. 2.

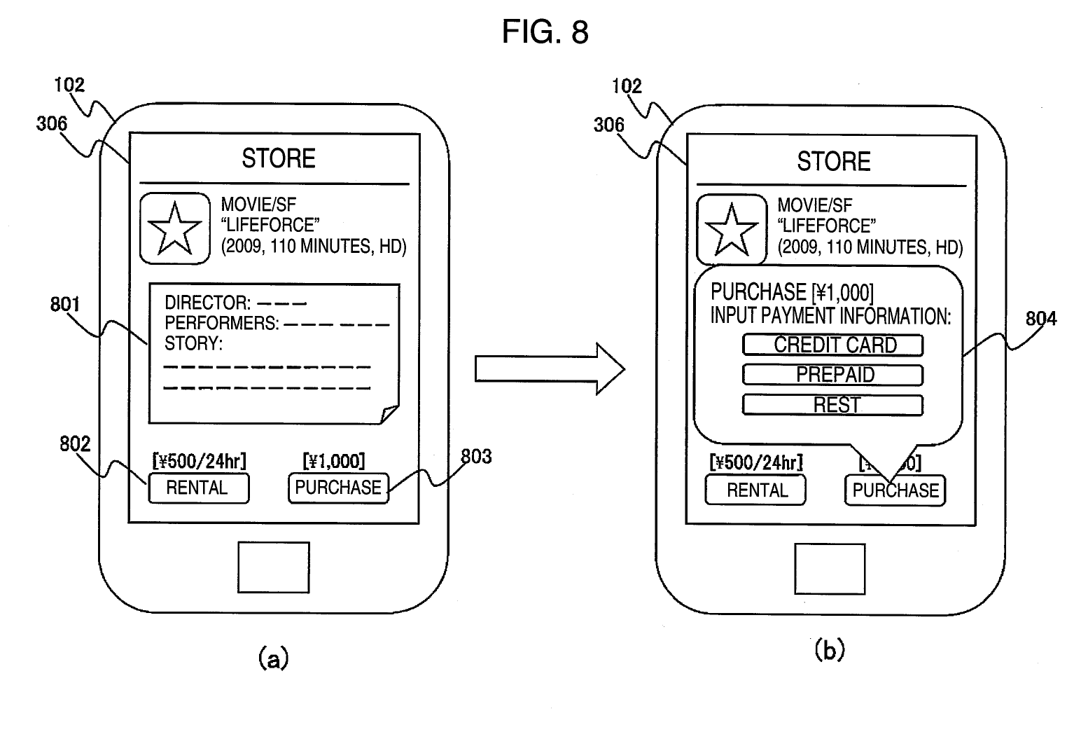

Subsequently, FIG. 8(a) shows an example of a display output after the user inputs access information in the state in FIG. 7(b) and the access information is authenticated by the authentication server 107. Reference numeral 801 denotes detailed information of data of the icon 701. In this case, data of the icon 701 is movie contents. A name of a director, names of performers, an outline, and so forth are shown as the detailed information 801. Reference numeral 802 denotes a rental button, and 803 a purchase button. In a case where data acquisition is not necessary, but it is only necessary to view the contents during only a predetermined period, the user selects the rental button 802. In a case where the user desires to acquire the data completely, the user selects the purchase button 803.

FIG. 8(b) shows an example of a display output in a case where the user has selected the purchase button 803. As indicated by 804, charge information for purchasing the contents is shown to urge the user to input payment information. This corresponds to the case of step S205 in FIG. 2.

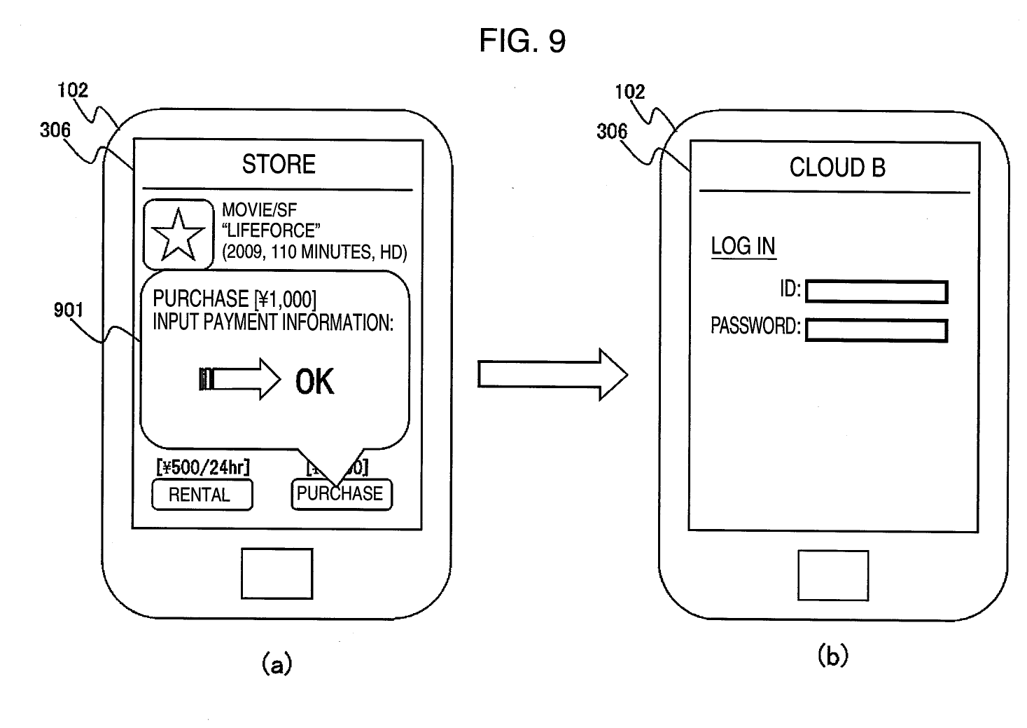

Subsequently, FIG. 9(a) shows an example of a display output after the user inputs payment information in the state of FIG. 8(b) and the payment information is authenticated by the authentication server. As indicated by 901, it is displayed that payment authentication has succeeded. This corresponds to the case of step S208 in FIG. 2.

FIG. 9(b) shows an example of a display output after the display of the payment authentication success. For starting the data transfer, input of access information to the cloud service becomes necessary. Display outputs as far as FIG. 9(a) are given by application software (referred to as application A) provided by the contents providing service 104. On the other hand, the display output shown in FIG. 9(b) becomes a display output given by application software (referred to as application B) provided by the cloud service 108. As for a configuration of software, the software is configured to call the application B in a case where data storage in some software is needed in the mobile terminal 102. As a result, the display output shown in FIG. 9(b) is implemented. If the user inputs access information for the cloud service 108 in FIG. 9(b), a notice of the access information is given to the server 109 together with the access information (including a data access key of purchase data) of the contents providing service 104. This corresponds to the case of step S209 in FIG. 2.

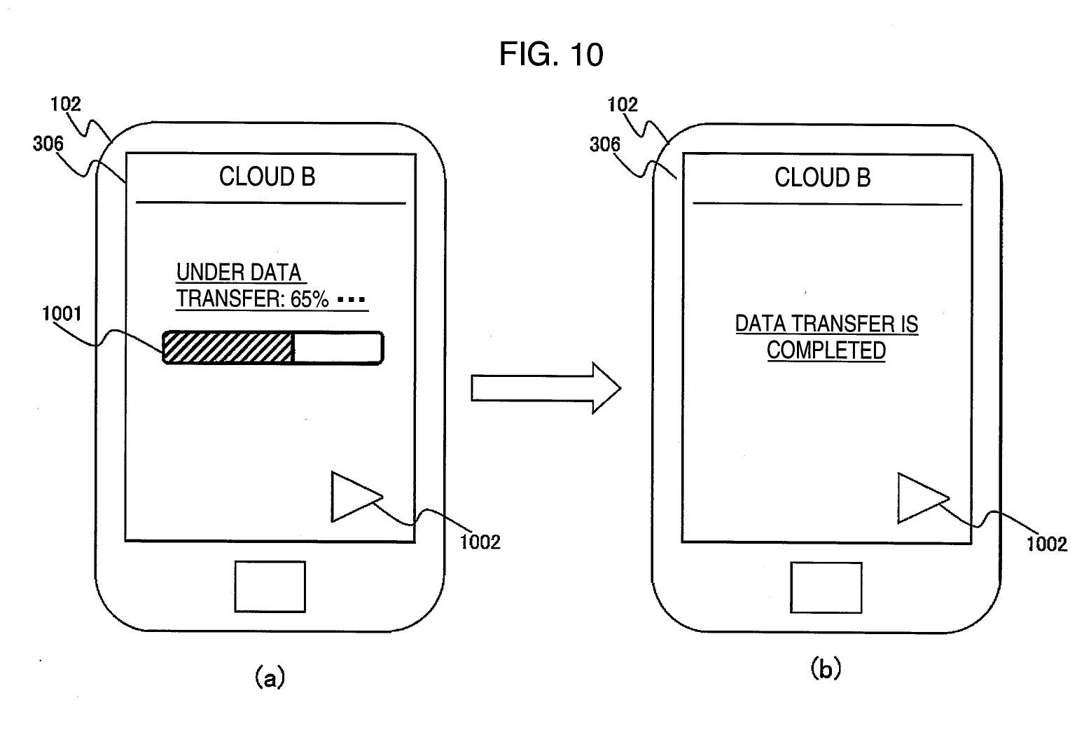

Subsequently, FIG. 10(a) shows an example of a display output after data transfer from the server 105 to the server 109 is started on the basis of access authentication conducted by the authentication server 111 in the cloud service 108 and the data request and the data access key sent from the server 109 to the server 105 after the operation shown in FIG. 9(b). A notice of progress of the data transfer is given by the server 109, and the progress is displayed in a bar form 1001. This corresponds to the case of the step S213 in FIG. 2.

FIG. 10(b) shows an example of a display output in a case where the data transfer is finished, the server 105 gives a completion notice to the server 109, and the server 109 gives a completion notice to the mobile terminal 102 as well. This corresponds to step S215 in FIG. 2. By the way, as for a reproduction button 1002, its operation will be described later.

According to the present embodiment, a display output that is easy to recognize is given to the user in each step as described heretofore. As a result, it is possible to implement an intuitive operation of the user and conduct operation of data transmission/reception corresponding to the first embodiment smoothly.

By the way, in the present embodiment, designs of display outputs shown in respective diagrams are not restricted. Any design may be used as described above as long as it reflects an operation flow in each step and the user can operate intuitively. Furthermore, as for the input of access information in the contents providing service 104 shown in FIG. 7(b) and the input of access information in the cloud service 108 shown in FIG. 9(b), it is also possible to make the respective steps unnecessary if the inputs were set previously. For example, if the access information in the cloud service 108 is already input and set, it is possible to provide a configuration in which data transfer is automatically started if the payment authentication is conducted in FIG. 9(a).

### Embodiment 4

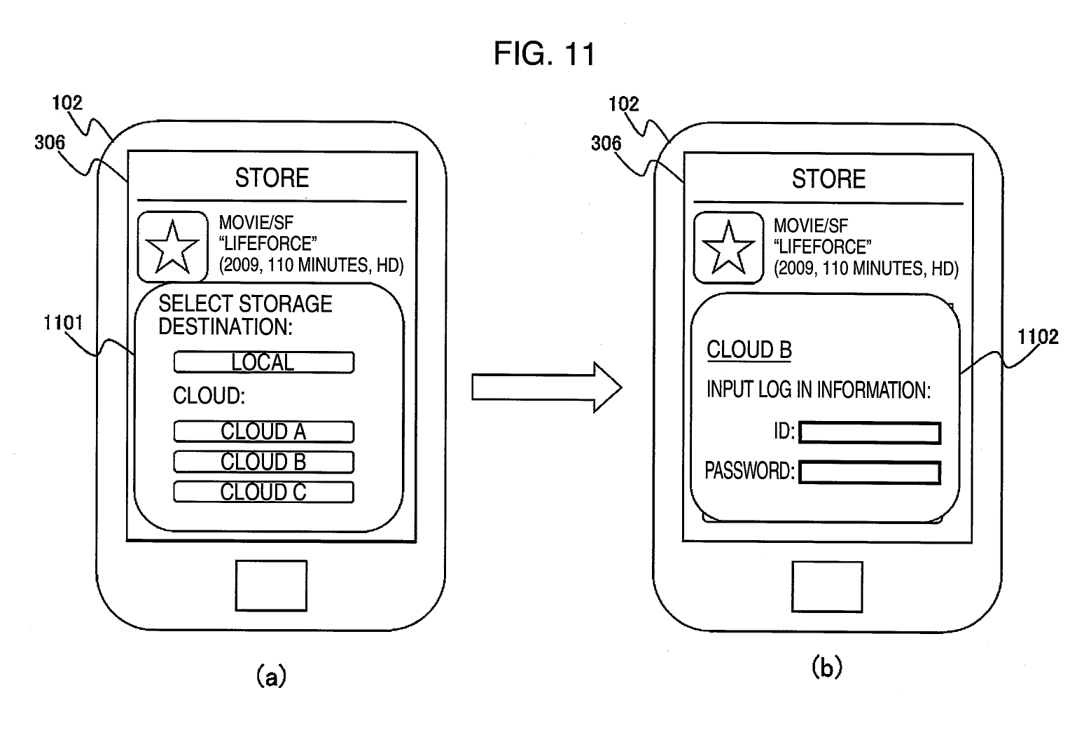

A fourth embodiment of the present invention will now be described with reference to FIG. 11.

FIG. 11 is a diagram showing an example of a display output in the mobile terminal 102 in the same way as FIGS. 7 to 10. FIG. 11 shows a display output of the display unit 306 in FIG. 3.

The present embodiment corresponds to the second embodiment, i.e., the operation flow shown in FIG. 6. Steps S601 to S608 in FIG. 6 can be implemented in the same form as the display outputs shown in FIGS. 7 to 9(a). The present embodiment differs in that the display output shown in FIG. 9(a) is not followed by the display output shown in FIG. 9(b) but followed by the display output shown in FIG. 11(a). In FIG. 11(a), the above-described changeover from the application A to the application B is not conducted, but the application A remains. In that state, selection of a data storage destination as indicated by 1101 is conducted. Software is implemented by configuring the application A to previously set the storage 302 incorporated in the mobile terminal 102 and a usable external cloud service as storage destinations. If the user selects “cloud B” corresponding to the cloud service 108 from among a plurality of storage destinations, a display output that urges the user to input access information of the cloud service 108 as indicated by 1102 in FIG. 11(b) is obtained. If the user inputs necessary access information, a notice of the access information is given to the server 105 together with an instruction to set the data transfer destination to the cloud service 108. This corresponds to the case of step S609 in FIG. 6. Subsequently, steps ranging from the data request in step S610 to the data transfer completion notice in 5614 are executed one after another. A changeover from the application A does not occur. A display output with, for example, display contents updated in 1102 in FIG. 11(b) can be obtained.

According to the present embodiment, a display output that is easy to recognize is given to the user in each step as described heretofore in the same way as the case of the third embodiment. As a result, it is possible to implement an intuitive operation of the user and conduct operation of data transmission/reception corresponding to the second embodiment smoothly.

By the way, in the present embodiment as well, designs of display outputs shown in respective diagrams are not restricted in the same way as the third embodiment. Any design may be used as described above as long as it reflects an operation flow in each step and the user can operate intuitively. Furthermore, as for the input of access information in the cloud service 108 shown in FIG. 11(b), it is also possible to make the respective steps unnecessary if the input was set previously. For example, if the access information in the cloud service 108 is already input and set, it is possible to provide a configuration in which data transfer is automatically started if selection of the data storage destination is conducted in FIG. 11(a). In addition, it is also possible to use a configuration in which the selection itself of the data storage destination in FIG. 11(a) is previously set and selection in this step is made unnecessary.

### Embodiment 5

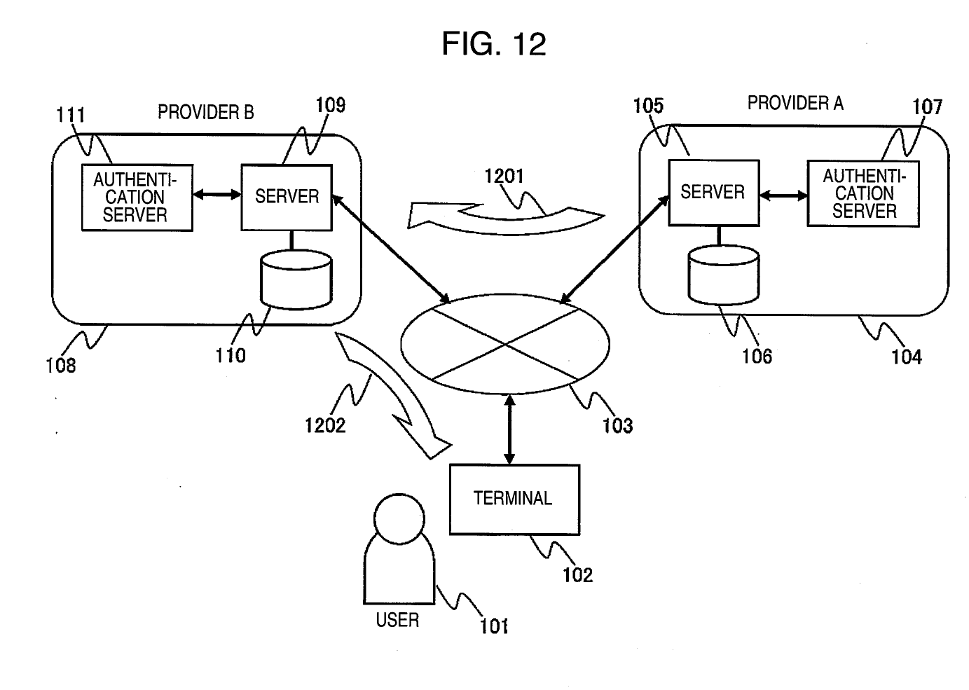

A fifth embodiment of the present invention will now be described with reference to FIG. 12 and FIG. 10 described above.

FIG. 12 is a schematic diagram showing an example of the data transmission/reception system according to the present invention. A flow of data is added to the configuration shown in FIG. 1. Since the same reference numerals as those in FIG. 1 are used, detailed description of respective components will be omitted. A feature of the present embodiment is that while the contents providing service 104 is sending data directly to the cloud service 108 (as indicated by 1201) the mobile terminal 102 receives streaming delivery from the cloud service 108 (as indicated by 1202).

According to the embodiments described heretofore, data transfer from the contents providing service 104 to the cloud service 108 is possible. In a case where the data is movie contents or the like, however, it takes some time to transfer the data. There is a demand of the user to view the purchased data earlier in some cases. While conducting data transfer from the contents providing service 104 to the cloud service 108, therefore, data transfer from the cloud service 108 to the mobile terminal 102 is conducted at the same time. However, the data transfer in this case is not downloading, but streaming delivery in which viewing is continued while conducting cash advance. Specifically, in the step shown in FIG. 10(a), the user touches the reproduction button 1002 and conducts instruction input. Taking advantage of this, the mobile terminal 102 gives a notice of instruction of data transfer to the server 109. The server 109 reads out data that are transferred from the server 105 and are being stored into the storage 110, and starts transfer to the mobile terminal 102. The mobile terminal 102 decodes the transferred data, and conducts display output of an image to the display unit 306 and voice output to the voice input/output terminal (a speaker/earphone terminal). Software in the mobile terminal is implemented by configuring the above-described application B not to store the transferred data but conduct reproduction operation of data as behavior of streaming. By the way, as for the reproduction operation, it is also possible to configure for the application B to call other application software dedicated for reproduction.

According to the present embodiment, it is possible to implement streaming viewing of image data or the like while executing data transmission/reception without intervention of the user terminal as described heretofore. As a result, convenience of the user can be further improved. Since the transferred data is only cached in a memory area in the user terminal temporarily, the data capacity of the storage in the user terminal is not pressed.

By the way, in the present embodiment, the streaming operation is started taking advantage of the reproduction button 1002 shown in FIG. 10(a). This is not restricted to the form as long as the user's instruction input can be conducted intuitively.

### Embodiment 6

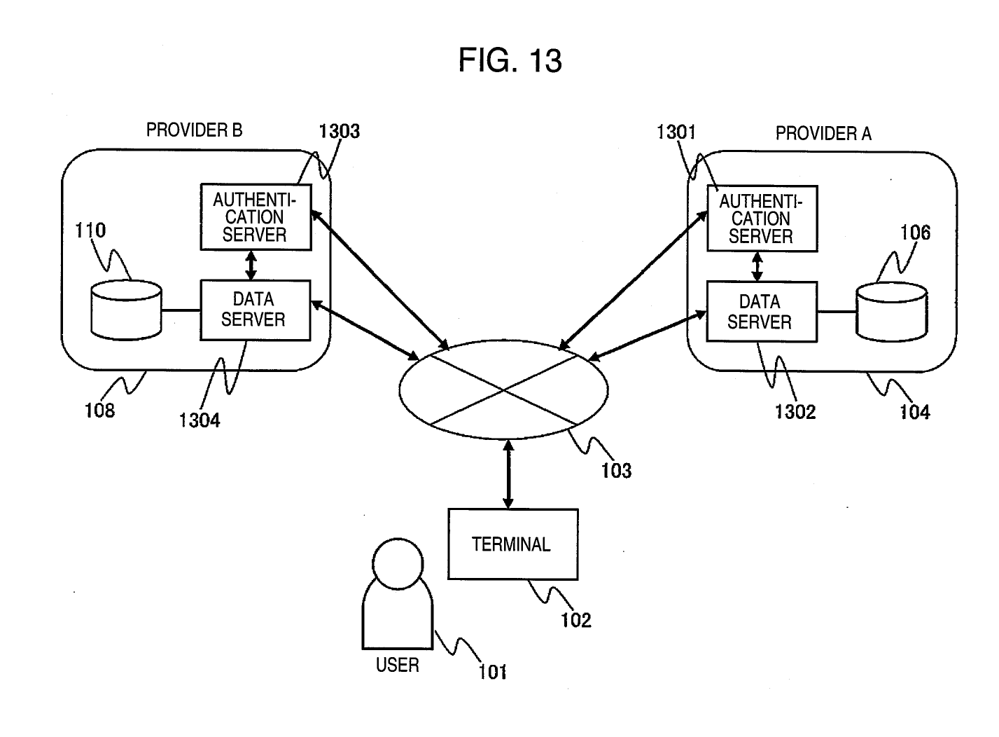

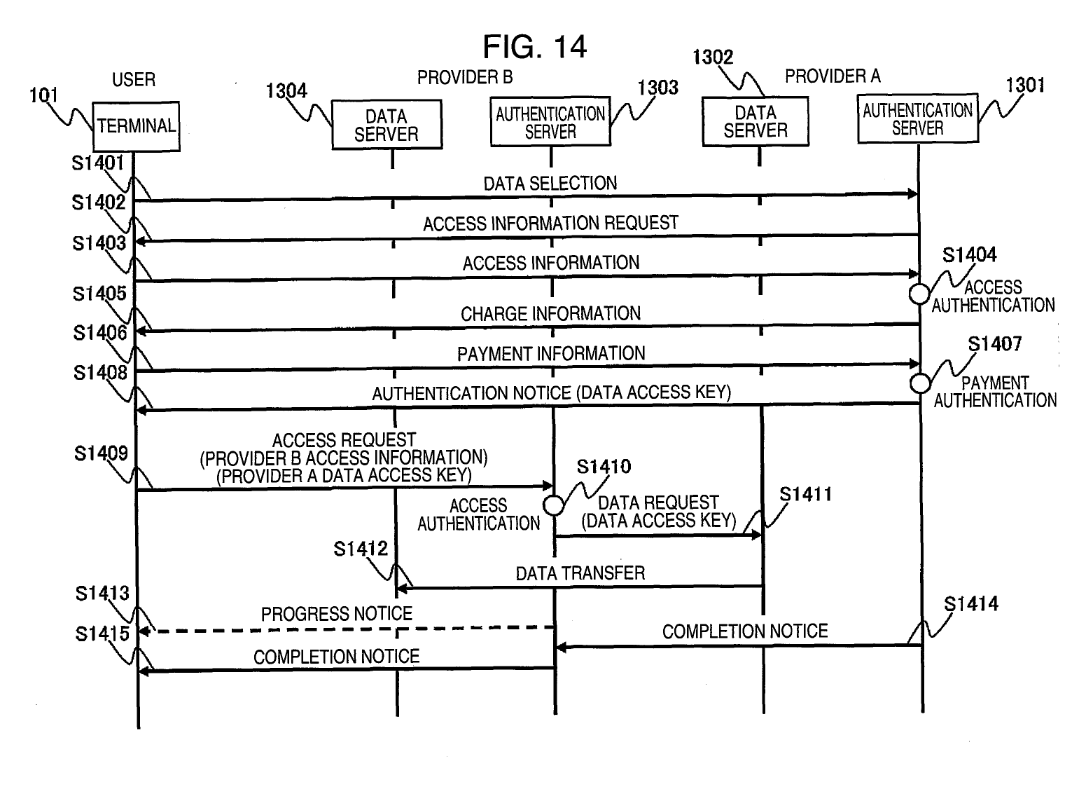

A sixth embodiment of the present invention will now be described with reference to FIGS. 13 and 14.

FIG. 13 is a schematic diagram showing the sixth embodiment of the data transmission/reception system according to the present invention. Basically, a configuration similar to that in the above-described embodiments is shown. Another example of the configuration of the server and the storage in the contents providing service 104 and the cloud service 108 is shown. By the way, components similar to those in FIG. 1 are denoted by like reference numerals, and detailed description will be omitted. Reference numeral 1301 denotes an authentication server in the contents providing service 104, 1302 a data server, 1303 an authentication server in the cloud service 108, and 1304 a data server.

An operation of the data transmission/reception system shown in FIG. 13 will now be described with reference to an operation flow shown in FIG. 14. A flow of data in the data sending from the contents providing service 104 to the cloud service 108 is basically the same as the operation flow in FIG. 2. The user 101 acquires desired data from the contents providing service 104, and stores the data in the storage 110 in the cloud service 108 contracted by the user. In the same way as the case of the above-described embodiments, the acquired data is not downloaded to the storage in the mobile terminal 102.

The user 101 accesses a web page prepared by the contents providing service 104 via the Internet 103 by using a web browser in the mobile terminal 102 or application software (such as the above-described application A) provided by the contents providing service 104, and selects desired data from among data stored in the storage 106 (S1401). The present embodiment differs from the above-described embodiments in that the authentication server 1301 plays a role of displaying a list of data instead of the web server. The authentication server 1301 requests access information in response to the data selection (S1402). The user 101 inputs access information (such as a user ID and a password) to the mobile terminal 102, A notice of them is given to the authentication server 1301 (S1403). The authentication server 1301 conducts access authentication on the basis of the received access information (S1404). In a case where the access authentication has failed, a request for access information is issued again (not illustrated). In a case where the access authentication has succeeded, a notice of charge information and so forth of the selected data is given (S1405). The user 101 inputs payment information (such as a credit card number) to the mobile terminal, and a notice of them is given to the authentication server 1301 (S1406). Predetermined payment authentication is conducted in the authentication server 1301 (S1407). If the payment authentication has succeeded, the authentication server 1301 gives an authentication notice to the mobile terminal 102 (S1408). In this case, the authentication notice includes a data access key, which makes access to the selected data possible. The user 101 issues an access request to the authentication server 1303 in the cloud service 108 by using the mobile terminal 102. In addition, the user 101 gives a notice of access information for the cloud service 108 and an access order (including a data access key) to the contents providing service 104 (S1409). The authentication server 1303 conducts access authentication on the basis of the received access information of the cloud service 108 (S1410). In a case where the access authentication has failed, a request for access information is issued to the mobile terminal 102 again (not illustrated). In a case where the access authentication has succeeded, the authentication server 1303 issues a data request to the data server 1302 in the contents providing service 104 on the basis of the above-described access instruction. In addition, a notice of the above-described data access key is given (S1411). The data server 1301 reads out data selected by the user 101 in step S1401 from the storage 106 on the basis of the data access key, and transfers the data to the data server 1304 in the cloud service 108 (S1412). The data server 1304 stores the received data into the storage 110. The authentication server 1303 gives a notice of progress of the data transfer to the mobile terminal 102 successively or at suitable timing (S1413). If the data transfer is finished, the authentication server 1301 gives a completion notice to the authentication server 1303 (S1414). The authentication server 1303 gives a completion notice to the mobile terminal 102 (S1415).

According to the present embodiment, a notice of authentication information concerning access and charging is given to a suitable server, and mainly the cloud service is caused to operate to acquire data directly from the contents providing service, as described heretofore in the same way as the case of the first embodiment. Even in a case of between different servers as in the contents providing service and the cloud service, therefore, it becomes possible to conduct transmission/reception of data smoothly without passing through the user terminal, i.e., without pressing the data capacity of the storage incorporated in the user terminal hard. Furthermore, owing to the server configuration according to the present embodiment, it is possible to describe the operation in the case of the above-described second embodiment in the same way. In that case, mainly the contents providing service is caused to operate to send data directly to the cloud service. Therefore, it becomes possible to conduct transmission/reception of data smoothly without passing through the user terminal, i.e., without pressing the data capacity of the storage incorporated in the user terminal hard.

The embodiments have been described by using an example in which the contents providing service 104 has one storage 106 and the cloud service 108 has one storage 110. However, the number of storages is not restricted, but a plurality of storages may be included. Furthermore, the case where movie contents are acquired from the contents providing service 104 as data has been described. However, classification of data is not restricted to this. In addition, in the description of FIGS. 7 to 11, the mobile terminal including the display unit having the touch panel function is used as the user terminal. In a case where a personal computer or the like is used, however, the user's instruction is given by using keyboard inputting. Application software corresponding to the user terminal function can be used as long as a series of functions can be executed. Therefore, the user terminal is not restricted to the above-described form.

Furthermore, the present invention is not restricted to the above-described embodiments, but various modifications are included. For example, the above-described embodiments have been described in detail to facilitate understanding the present invention. The present invention is not necessarily restricted to a configuration having all described components.

In addition, a portion or the whole of each of functions, processing units and so forth described above may be implemented with hardware by designing using an integrated circuit, or may be implemented with software by causing a processor to interpret and execute programs that implement respective functions. Furthermore, as for control lines and information lines, lines considered to be necessary in description are indicated. All control lines and information lines are not necessarily indicated.

### REFERENCE SIGNS LIST

101: User
102: Mobile terminal
103: Internet
104: Contents providing service
105, 109: Server
106, 110: Storage
107, 111: Authentication server
108: Cloud service
301: Control unit
302: Storage
303: Network processing unit
304: Input/output terminal
305: Image processing unit
306: Display unit
307: User I/F processing unit
308: Input terminal
309: Voice processing unit
310: Input/output terminal
1301, 1303: Authentication server
1302, 1304: Data server

1. A terminal device in a data transmission/reception system including the terminal device, a data providing subsystem, and a data storing subsystem connected to each other via a network, the terminal device comprising:
a network processor to conduct connection to the network;
a user interface to input a user's instruction;
a display to conduct display output of an image; and
a controller to control respective elements in the terminal device,
the controller outputting a display output requesting an input of first information to the display to get access permission of first data retained by a first server included in the data providing subsystem,
the controller giving a notice of the first information input by the user interface to the first server via the network processor,
the controller outputting a display output to the display to urge selection of a storage destination of the first data,
in a case where the data storing subsystem is selected as the storage destination by an input from the user interface, the controller giving a notice of second information for accessing a second server included in the data storing subsystem to the first server via the network processor together with an instruction to send the first data to the second server specified as a data sending destination.

2. The terminal device according to claim 1, wherein the first information includes access information and payment information of the user.

3. A terminal device in a data transmission/reception system including the terminal device, a data providing subsystem, and a data storing subsystem connected to each other via a network, the terminal device comprising:
a network processor to conduct connection to the network;
a user interface to input a user's instruction;
a display to conduct display output of an image; and
a controller to control respective elements in the terminal device,
the controller giving a notice to a second server included in the data storing subsystem to cause the second server to issue an acquisition request for first data retained by a first server included in the data providing subsystem to the first server, via the network processor together with authentication information that authenticates access to the first data, and
thereby the control unit causing sending of the first data from the first server to the second server.

4. The terminal device according to claim 3, wherein the authentication information includes third information that permits access to the first data.

5. The terminal device according to claim 1, wherein the control unit receives a transmission/reception situation of the first data from the first server to the second server, via the network processor, and outputs a ratio of transmitted/received data to a total amount of the first data to the display output unit on the basis of the transmission/reception situation.

6. The terminal device according to claim 1, wherein
the display conducts the display output of an image of a list display of a plurality of data storing subsystems connected to the terminal device via the network as a storage destination of data acquired from the data providing subsystem, one data storing subsystem being selected from among the plurality of data storing subsystems displayed in the list display as the storage destination on the basis of an input from the user interface.

7-12. (canceled)

13. A data transmission/reception method conducted by a data storing subsystem in a data transmission/reception system including a terminal device, a data providing subsystem, and the data storing subsystem,
in a case where information for accessing first data retained by a first server in the data providing subsystem is received from the terminal device, a second server in the data storing subsystem issuing an acquisition request of the first data to the first server, and sending of the first data from the first server to the second server being caused to be executed.

14. The data transmission/reception method according to claim 13, wherein in a case where a delivery request for the first data is issued by the terminal device during a period of execution of sending of the first data from the first server to the second server, the second server delivers the first data sent from the first server to the terminal device successively.

15. A data transmission/reception method conducted by a data providing subsystem in a data transmission/reception system including a terminal device, the data providing subsystem, and a data storing subsystem,
in a case where a sending instruction of first data retained by the first server in the data providing subsystem with a second server in the data storing subsystem specified as a data sending destination and information for accessing the second server are received from the terminal device, sending of the first data from the first server to the second server being caused to be executed.

16-21. (canceled)
